(19) United States
(12) Patent Application Publication
(10) Pub. No.: US 2009/0108818 A1
(43) Pub. Date: Apr. 30, 2009

(54) SWITCHING POWER SUPPLY CIRCUIT

(75) Inventors: Hiroko Murayama, Osaka (JP); Kazuhiro Murata, Osaka (JP); Yoshihiro Mori, Kyoto (JP)

Correspondence Address: STEPTOE & JOHNSON LLP, 1330 CONNECTICUT AVE., NW, WASHINGTON, DC, 20036, US

(73) Assignee: Panasonic Corporation, Kadoma-shi (JP)

(21) Appl. No.: 12/255,760

(22) Filed: Oct. 22, 2008

(30) Foreign Application Priority Data
Oct. 26, 2007 (JP) 2007-278250

(51) Int. Cl. G05F 1/10

(52) U.S. Cl. 323/234

(57) ABSTRACT

According to the present invention, an auxiliary power supply 10 which supplies a power supply voltage to a photocoupler 9 for feeding back fluctuations in the voltage of an output part 2 is only made up of a diode for passing a current only through the collector of a phototransistor 92 from a positive voltage terminal 21 of the output part 2, and a capacitor 105 inserted between the joint of a source terminal 34 of a three-terminal switching regulator 3 and a coil 5 and the joint of the diode 104 and the collector of the phototransistor 92.

### FIELD OF THE INVENTION

The present invention relates to a switching power supply circuit which stabilizes an output voltage by using a three-terminal switching regulator, as a non-isolated power supply circuit for stabilizing a DC output voltage.

### BACKGROUND OF THE INVENTION

Conventionally, a switching power supply circuit for stabilizing an output voltage by using a three-terminal switching regulator has been widely used as, for example, a non-isolated power supply circuit for stabilizing a DC output voltage in a power supply circuit to be installed into electronic equipment.

A switching power supply circuit of the prior art will be described below.

FIG. 7 is a schematic circuit diagram showing the configuration of the switching power supply circuit according to the prior art. As shown in FIG. 7, for example, the switching power supply circuit of the prior art is made up of an input part 1, an output part 2, a three-terminal switching regulator 3 fed with an input voltage VIN from the input part 1, a capacitor 4 for supplying a power supply voltage of the three-terminal switching regulator 3, a first coil 51 inserted between the three-terminal switching regulator 3 and the output part 2, a capacitor 6 for smoothing a voltage outputted from the first coil 51 to the output part 2, a diode 7 having the cathode connected to the joint of the three-terminal switching regulator 3 and the first coil 51 and the anode connected to a negative voltage terminal 22 of the output part 2, an output voltage detection part 8 for detecting an output voltage VO of the output part 2, a photocoupler 9 for feeding, to the three-terminal switching regulator 3, a current signal corresponding to the output voltage VO having been detected by the output voltage detection part 8, and an auxiliary power supply 10 for supplying a voltage between the emitter and collector of a phototransistor 92 of the photocoupler 9.

First, the three-terminal switching regulator 3 will be described below.

The three-terminal switching regulator 3 includes a switch 31 and a controller 32 and has three terminals 33, 34 and 35. The switch 31 is made up of, for example, a power MOS-FET transistor, and the oscillation (switching) of the switch 31 is controlled by the controller 32. Of the terminals of the three-terminal switching regulator 3, the terminal connected to the input part 1 will be referred to as the drain terminal 33, the terminal connected to the first coil 51 will be referred to as the source terminal 34, and the terminal connected to the photocoupler 9 will be referred to as the control terminal 35. The three-terminal switching regulator 3 performs PWM control for changing the on duty of the switch 31 according to an amount of current flowing from the phototransistor 92 into the control terminal 35. The control terminal 35 also supplies a power supply voltage VC of a control circuit in the controller 32.

The following will discuss the auxiliary power supply 10 for supplying power to the phototransistor 92 in the photocoupler 9.

The auxiliary power supply 10 is made up of a smoothing circuit which includes a second coil 101 electromagnetically coupled to the first coil 51, a diode 102 for smoothing a current from the second coil 101 and flowing the current into the collector of the phototransistor 92, and a capacitor 103.

The following will describe the operations of the switching power supply circuit configured thus according to the prior art.

FIG. 8 is a waveform chart showing the operations of the parts of the switching power supply circuit according to the prior art. In FIG. 8, a waveform (1) IL is an image of a current passing through the first coil 51, a waveform (2) VL is an image of a potential difference on the first coil 51, a waveform (3) VB is an image of a voltage on the diode 102 of the second coil 101 (point B in FIG. 7), and a waveform (4) VB′ is an image of a collector voltage of the phototransistor 92 (point B′ in FIG. 7).

In FIG. 8, TON is an on period of the switch 31, TOFF is an off period of the switch 31, VS is the voltage of the source terminal 34, and VC is the voltage of the control terminal 35. The waveform (3) VB and the waveform (4) VB′ are operation waveforms relative to the voltage VS of the source terminal 34. Further, the operation waveforms of FIG. 8 are created in a forward direction that is the direction of an arrow for the current IL of the first coil 51 shown in FIG. 7.

When the input voltage VIN is applied to the input part 1, the input voltage VIN is applied to the drain terminal 33 of the three-terminal switching regulator 3. When the first coil 51 has an inductance of L, the inclination of the time variation of the current IL passing through the first coil 51 is proportionate to VL/L. Thus as indicated by the waveform (2) in FIG. 8, in the on period TON of the switch 31, the drain terminal 33 and the source terminal 34 are electrically connected to each other to apply the input voltage VIN to the source terminal 34 of the first coil 51, causing a potential difference (VIN−VO) on the first coil 51 from the source terminal 34 to the output part 2. The value of the current IL in the forward direction increases and energy is charged to the first coil 51.

In the off period TOFF of the switch 31, the drain terminal 33 and the source terminal 34 are electrically disconnected from each other and a current passes through the diode 7, so that the potential of the source terminal 34 is reduced from GND by a forward voltage drop VF of the diode 7 and the potential of a positive voltage terminal 21 of the output part 2 becomes higher than the potential of the source terminal 34. Thus the value of the current IL passing through the first coil 51 decreases and the energy having been charged in the first coil 51 is outputted to the output part 2. The capacitor 6 smoothes the current and generates the output voltage VO. An output current IO is the mean value of the current IL passing through the first coil 51.

In steady-state oscillation, the on period TON and the off period TOFF are repeated and energy is supplied to a load (not shown) connected to the output part 2.

The output voltage detection part 8 detects the output voltage VO of the output part 2, converts an error between the output voltage VO and an output voltage set by power supply specifications into a current signal, and passes a current into a photodiode 91 of the photocoupler 9. The current passing through the photodiode 91 thus brings the phototransistor 92 of the photocoupler 9 into conduction and passes a current through the control terminal 35 according to the error of the output voltage VO. The controller 32 controls the switching of the switch 31 according to an amount of current passing through the control terminal 35 and thus the on duty of the switch 31 is changed so as to reduce the error of the output voltage VO, so that the output voltage VO is kept constant.

Further, a current passing through the phototransistor 92 also charges the capacitor 4 between the control terminal 35 and the source terminal 34 and forms the power supply voltage of the controller 32 with a potential difference between the control terminal 35 and the source terminal 34.

Electrical continuity (ON) for the phototransistor 92 of the photocoupler 9 requires the auxiliary power supply 10 which keeps a voltage between the collector and emitter of the phototransistor 92 and supplies a current passing through the phototransistor 92.

In the auxiliary power supply 10, the second coil 101 is electromagnetically coupled to the first coil 51 with polarity shown in FIG. 7. Thus as indicated by the waveform (3) of FIG. 8, in the on period TON of the switch 31, the source terminal voltage VS becomes higher than the voltage VB on the diode 102 according to fluctuations in the potential of the first coil 51, and in the off period TOFF of the switch 31, the voltage VB on the diode 102 conversely becomes higher than the source terminal voltage VS.

In steady-state oscillation, only when the collector voltage VB′ of the phototransistor 92 is lower than VB by a forward voltage drop VFO of the diode 102, a current is supplied from the point B to the point B′ and VB′ is formed. In other words, VB′ is a voltage formed by smoothing VB and simultaneously can be a power supply voltage of the phototransistor 92.

In the off period TOFF of the switch 31, the voltage VB on the diode 102 of the second coil 101 is higher than the source terminal voltage VS and the control terminal voltage VC. Thus as indicated by the waveform (4) of FIG. 8, a current passes through the diode 102 and the voltage VB′ is formed.

The formed VB′ is lower than VB by the forward voltage drop VFO of the diode 102. The turns ratio of the second coil 101 is set relative to the number of turns of the first coil 51 such that the formed VB′ is higher than the source terminal voltage VS and the control terminal voltage VC.

In the on period TON of the switch 31, the voltage VB on the diode 102 of the second coil 101 is lower than the control terminal voltage VC and thus does not allow the passage of a current through the diode 102 but VB′ is kept by the capacitor 103 so as not to be lower than the control terminal voltage VC. Consequently, VB′ is always higher than the control terminal voltage VC and the power supply voltage of the phototransistor 92 is ensured.

In the switching power supply circuit of the prior art (for example, see Japanese Patent Laid-Open No. 2002-6964, page 1, FIG. 1), the power supply voltage of the phototransistor 92 is always ensured by the second coil 101 electromagnetically coupled to the first coil 51 and the smoothing circuit made up of the diode 102 and the capacitor 103.

Thus the phototransistor 92 can simultaneously feed a current steadily back to the controller 32 according to the error of the power supply voltage and supply the power supply voltage of the controller 32, thereby achieving the aforementioned power supply control.

In the switching power supply circuit of the prior art, however, the auxiliary power supply 10 is made up of a large number of components. Further, of the constituent components of the auxiliary power supply 10, a transformer made up of the first coil 51 and the second coil 101 has to be designed and fabricated with proper characteristics according to power supply specifications, which has interfered with reducing the space and cost of the product.

### DISCLOSURE OF THE INVENTION

The present invention has been devised to solve the problem of the prior art. An object of the present invention is to provide a switching power supply circuit by which a circuit part for supplying a power supply voltage to a photocoupler (transfer device) for voltage control feedback can be made up of a smaller number of components than the prior art with a smaller size and lower cost as a non-isolated power supply circuit using a three-terminal switching regulator.

In order to solve the problem, a switching power supply circuit of the present invention includes: a switch for switching an input voltage; an energy transfer element for charging and outputting energy obtained by the switching of the switch; an output generation part for outputting a voltage while charging the energy outputted from the energy transfer element; an output voltage detection part for detecting the output voltage of the output generation part and generating a detection signal corresponding to the output voltage; a transfer device for outputting a transfer signal corresponding to the value of the detection signal generated by the output voltage detection part; an auxiliary power supply for supplying a power supply voltage for generating the transfer signal to the transfer device, based on the output voltage of the output generation part; and a controller for generating a driving signal for controlling the switching of the switch according to the value of the transfer signal from the transfer device, wherein the auxiliary power supply is only made up of: a rectifier device which is connected between one end of the output generation part and the transfer device and passes a current from the one end of the output generation part only to the transfer device; and a smoothing device for keeping and smoothing the potential of the joint of the rectifier device with the transfer device while using the switching output of the switch as a reference potential.

As has been discussed, the present invention can control the stabilization of an output voltage by feeding back fluctuations in the voltage of the output part with the transfer device fed with the power supply voltage from the auxiliary power supply only made up of the rectifier device and a capacitor, as a non-isolated power supply circuit using a three-terminal switching regulator.

Thus a circuit part for supplying a power supply voltage to the transfer device for voltage control feedback can be made up of a smaller number of components than the prior art with a smaller size and lower cost as a non-isolated power supply circuit using a three-terminal switching regulator.

### BRIEF DESCRIPTION OF THE DRAWINGS

FIG. 1 is a schematic circuit diagram showing the configuration of a switching power supply circuit according to a first embodiment of the present invention;

FIG. 2 is a waveform chart showing the operations of the switching power supply circuit according to the first embodiment;

FIG. 3 is a schematic circuit diagram showing the configuration of a switching power supply circuit according to a second embodiment of the present invention;

FIG. 4 is a schematic circuit diagram showing the configuration of a switching power supply circuit according to a third embodiment of the present invention;

FIG. 5 is a schematic circuit diagram showing the configuration of a switching power supply circuit according to a fourth embodiment of the present invention;

FIG. 6 is a waveform chart showing the operations of the switching power supply circuit according to the fourth embodiment;

FIG. 7 is a schematic circuit diagram showing the configuration of a switching power supply circuit according to the prior art; and

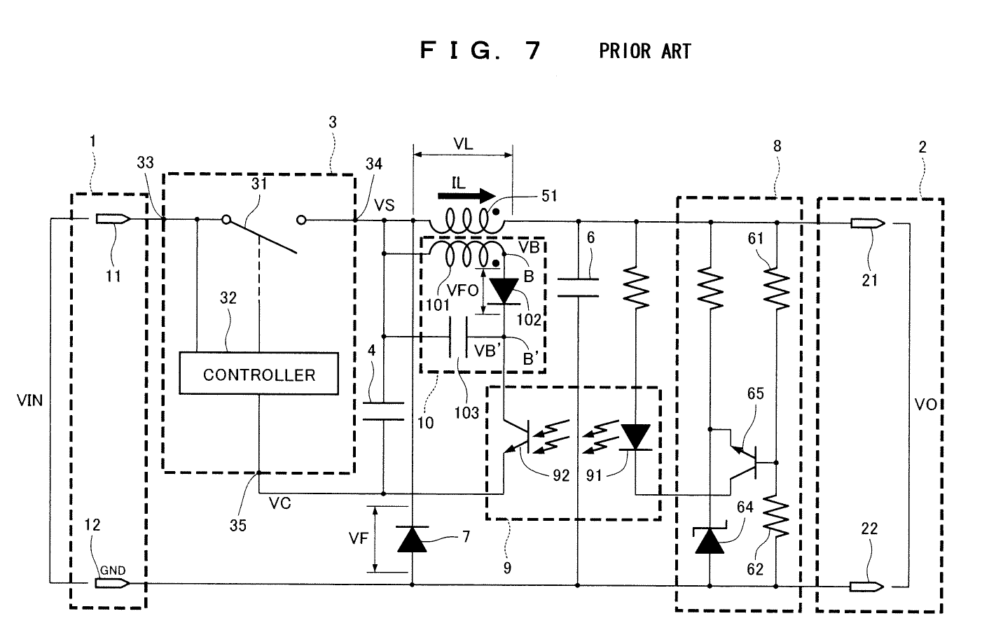

FIG. 8 is a waveform chart showing the operations of the switching power supply circuit of the prior art.

### DESCRIPTION OF THE EMBODIMENTS

A switching power supply circuit illustrating an embodiment of the present invention will be specifically described below with reference to the accompanying drawings. In the present embodiment, constituent elements indicated by the same reference numerals perform the same operations and thus the explanation thereof may be omitted. Further, the accompanying drawings are merely specific illustration of an embodiment of the present invention and the present invention is not limited to the accompanying drawings.

### First Embodiment

A switching power supply circuit according to a first embodiment of the present invention will be described below.

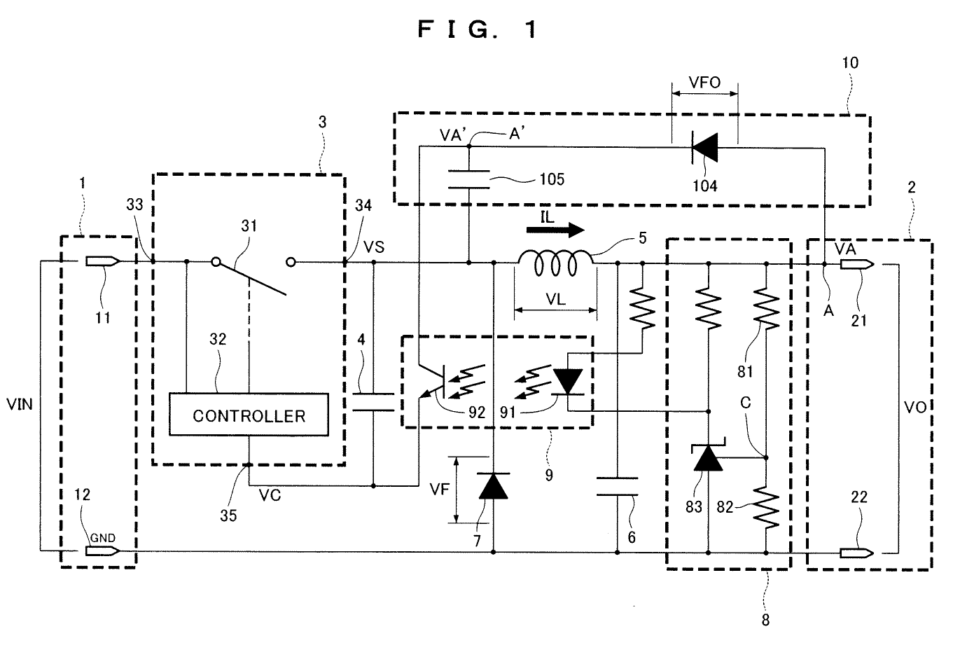

FIG. 1 is a schematic circuit diagram showing the configuration of the switching power supply circuit according to the first embodiment. As shown in FIG. 1, the switching power supply circuit of the first embodiment is made up of an input part 1, an output part 2, a three-terminal switching regulator 3 fed with an input voltage VIN from the input part 1, a capacitor 4 for supplying a power supply voltage of the three-terminal switching regulator 3, a coil 5 inserted between the three-terminal switching regulator 3 and the output part 2, a capacitor 6 for smoothing a voltage outputted from the coil 5 to the output part 2, a diode 7 having the cathode connected to the joint of the three-terminal switching regulator 3 and the coil 5 and the anode connected to a negative voltage terminal 22 of the output part 2, an output voltage detection part 8 for detecting an output voltage VO of the output part 2, a photocoupler 9 for feeding back, to the three-terminal switching regulator 3, a signal corresponding to the output voltage having been detected by the output voltage detection part 8, and an auxiliary power supply 10 for supplying a voltage between the emitter and collector of a phototransistor 92 of the photocoupler 9.

The output voltage detection part 8 is made up of a first resistor 81 and a second resistor 82 which are connected in series and inserted between a positive voltage terminal 21 and the negative voltage terminal 22 of the output part 2, and a shunt regulator 83 which has the reference voltage detecting terminal connected to the joint of the first resistor 81 and the second resistor 82, the cathode connected to a photodiode 91 of the photocoupler 9, and the anode connected to the negative voltage terminal 22 of the output part 2.

The auxiliary power supply 10 is made up of a rectifier device 104 which passes a current only to the collector of the phototransistor 92 from the positive voltage terminal 21 of the output part 2 and a capacitor 105 which is inserted between the joint of a source terminal 34 of the three-terminal switching regulator 3 and the coil 5 and the joint of the rectifier device 104 and the collector of the phototransistor 92.

The following will describe the operations of the switching power supply circuit configured thus.

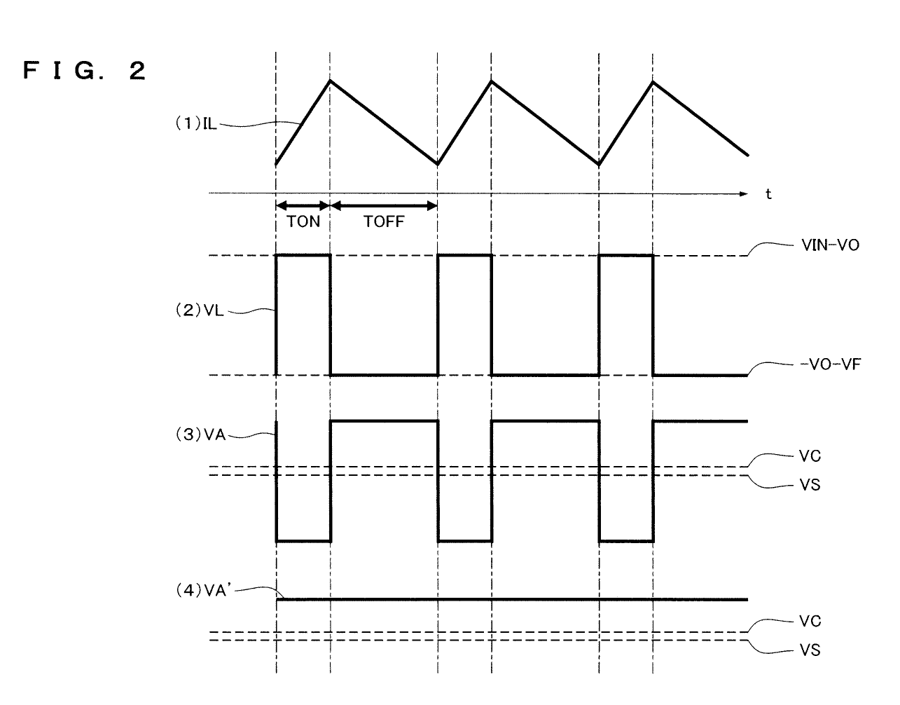

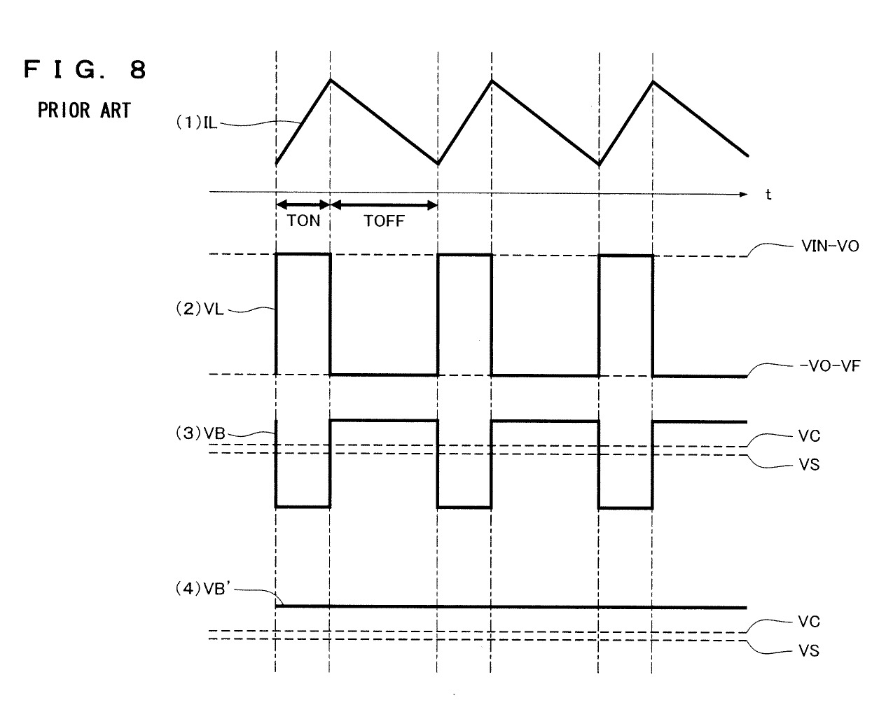

FIG. 2 is a waveform chart showing the operations of the switching power supply circuit according to the first embodiment. The following will only describe the operations of the output voltage detection circuit 8 and the auxiliary power supply 10 which are different from the prior art example, and an explanation is omitted about the operations of the parts having similar configurations to the prior art example. Since the operations of the three-terminal switching regulator 3 and the coil 5 are similar to the prior art example, a current IL passing through the coil as indicated by a waveform (1) of FIG. 2 and a potential difference VL occurring on the coil as indicated by a waveform (2) of FIG. 2 form operation waveforms similar to the waveforms of the current IL passing through the coil as indicated by the waveform (1) of the prior art example and the potential difference VL occurring on the coil as indicated by the waveform (2) of the prior art example shown in FIG. 8.

In FIG. 2, the waveform (1) IL is an image of the current passing through the coil 5, the waveform (2) VL is an image of the potential difference on the coil 5, a waveform (3) VA is an image of a voltage of the positive voltage terminal 21 of the output part 2 (point A in FIG. 1), and a waveform (4) VA′ is an image of a voltage of the collector of the phototransistor 92 (point A′ in FIG. 1).

In FIG. 2, TON is an on period of a switch 31, TOFF is an off period of the switch 31, VS is a voltage of the source terminal 34, and VC is a voltage of a control terminal 35. The waveform (3) VA and the waveform (4) VA′ are operation waveforms relative to the voltage VS of the source terminal 34. The operation waveforms of FIG. 2 are created in a forward direction that is the direction of an arrow for the current IL of the coil 5 shown in FIG. 1.

The resistance values of the first resistor 81 and the second resistor 82 of the output voltage detection part 8 are set such that when the output voltage VO of the output part 2 is equal to the output voltage of power supply specifications, the voltage of a joint C of the first resistor 81 and the second resistor 82 is equal to a reference voltage set beforehand in the shunt regulator 83.

When the output voltage VO increases or decreases, the voltage of the joint C of the first resistor 81 and the second resistor 82 increases or decreases accordingly, and the voltage of the joint C is applied to the reference voltage detecting terminal of the shunt regulator 83. An amount of current passing from the cathode to the anode of the shunt regulator 83 fluctuates with an error between the voltage of the joint C and the reference voltage of the shunt regulator 83.

When a current passes through the shunt regulator 83, the same amount of current passes through the photodiode 91 of the photocoupler 9, the phototransistor 92 is brought into conduction, and the current of the phototransistor 92 flows into the control terminal 35 of the three-terminal switching regulator 3 as a current signal of the error of the output voltage VO. A controller 32 controls the switching of the switch 31 according to an amount of current passing through the control terminal 35 and thus the on duty of the switch 31 changes so as to reduce the error of the output voltage VO, so that the output voltage VO is kept constant.

The current having passed through the phototransistor 92 also charges the capacitor 4 between the control terminal 35 and the source terminal 34, ensures a potential difference between the control terminal 35 and the source terminal 34, and forms the power supply voltage of the controller 32. In this case, the electrical continuity of the phototransistor 92 of the photocoupler 9 requires the auxiliary power supply 10 which keeps a voltage between the collector and emitter of the phototransistor 92 and supplies the current passing through the phototransistor 92.

Relative to the voltage VS of the source terminal 34, as indicated by the waveform (3) of FIG. 2, a forward voltage is generated on the coil 5 in the on period TON of the switch 31, so that the source terminal voltage VS is higher than the voltage VA of the positive voltage terminal 21 of the output part 2. In the off period TOFF of the switch 31, a voltage is generated on the coil 5 in the opposite direction from the forward direction, so that the voltage VA of the positive voltage terminal 21 of the output part 2 is higher than the source terminal voltage VS.

In steady-state oscillation, only when the collector voltage VA′ of the phototransistor 92 is lower than VA by a forward voltage drop VFO of the diode 104, a current is supplied from the point A to the point A′ and VA′ is formed.

In the off period TOFF of the switch 31, as indicated by the waveform (3) of FIG. 2, the voltage VA of the positive voltage terminal 21 of the output part 2 is higher than the source terminal voltage VS and the control terminal voltage VC. Thus as indicated by the waveform (4) of FIG. 2, a current passes through the diode 104 and the voltage VA′ is formed. The formed VA′ has a potential lower than VA by the forward voltage drop VFO of the diode 104. In this case, the value of the output voltage VO has to enable the formed VA′ to be higher than the source terminal voltage VS and the control terminal voltage VC.

In the on period TON of the switch 31, the voltage VA of the positive voltage terminal 21 of the output part 2 is lower than the control terminal voltage VC, so that a current does not pass through the diode 104 and VA′ is kept by the capacitor 105 so as not to be lower than the control terminal voltage VC. Consequently, VA′ is always higher than the control terminal voltage VC and the power supply voltage of the phototransistor 92 is ensured. The phototransistor 92 can simultaneously feed a current steadily back to the controller 32 according to the error of the power supply voltage and supply the power supply voltage of the controller 32, thereby achieving the aforementioned power supply control.

As has been discussed, according to the first embodiment, the power supply voltage of the phototransistor 92 can be supplied only by the single diode 104 and the single capacitor 105. The prior art requires the transformer made up of the first coil 51 and the second coil 101 electromagnetically coupled to the first coil 51, whereas in the present embodiment, a transformer is not necessary and the auxiliary power supply is only made up of the coil 5, thereby reducing the cost and size.

In the first embodiment, the switch 31 is controlled by the controller 32 according to a PWM control method in which a duty is changed. The control method is not limited to the PWM control method and may be a current mode PWM control method in which the peak of current passing between the drain terminal 33 and the source terminal 34 is changed, a PFM control method in which a frequency is changed, and an intermittent control system in which an oscillation period and an oscillation stop period are repeated.

According to the first embodiment, the output voltage detection part 8 is made up of the resistors 81 and 82 and the shunt regulator 83. The configuration of the output voltage detection part 8 is not particularly limited and any configuration may be used as long as the error of the output voltage VO of the output part 2 can be detected, the error can be converted into a current signal, and the current can be passed through the photodiode 91 of the photocoupler 9.

### Second Embodiment

A switching power supply circuit according to a second embodiment of the present invention will be described below.

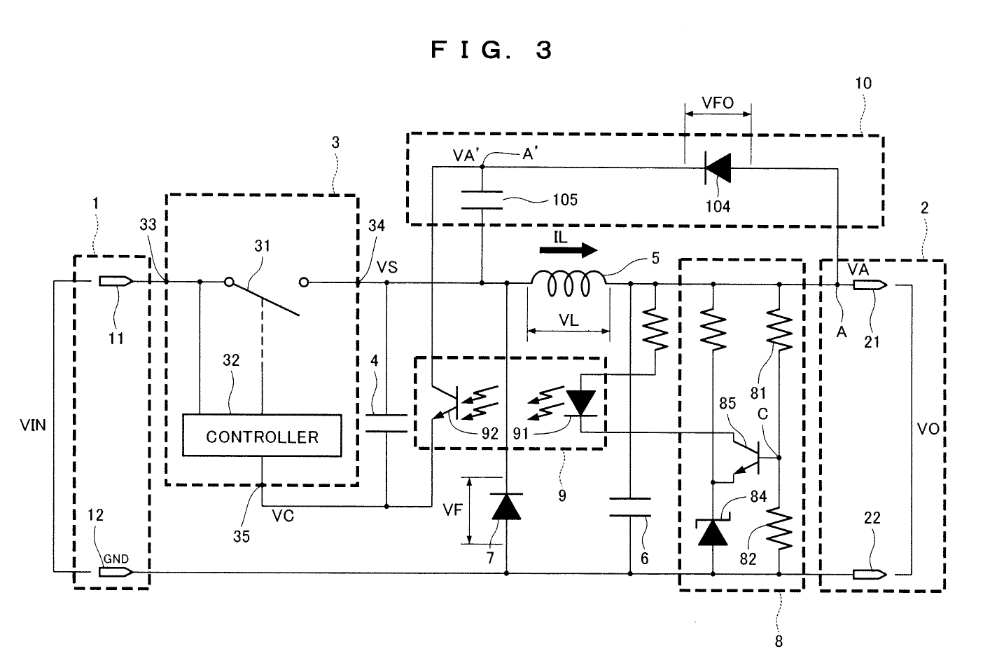

FIG. 3 is a schematic circuit diagram showing the configuration of the switching power supply circuit according to the second embodiment. The circuit capable of detecting the error of the output voltage VO of the output part 2, converting the error into the current signal, and passing the current through the photodiode 91 of the photocoupler 9 in the first embodiment can be made up of, for example, a first resistor 81, a second resistor 82, a Zener diode 84, and a transistor 85 as shown in FIG. 3.

In an output voltage detection part 8 of FIG. 3, the voltage of a joint C of the first resistor 81 and the second resistor 82 changes with fluctuations in an output voltage VO of an output part 2, and the voltage of the joint C is applied to the base of the transistor 85. A current passes through the collector and emitter of the transistor 85 according to fluctuations in voltage applied to the base and the current flows from the cathode of a photodiode 91. Thus the current passes through the photodiode 91 according to the error of the output voltage VO of the output part 2.

### Third Embodiment

A switching power supply circuit according to a third embodiment of the present invention will be described below.

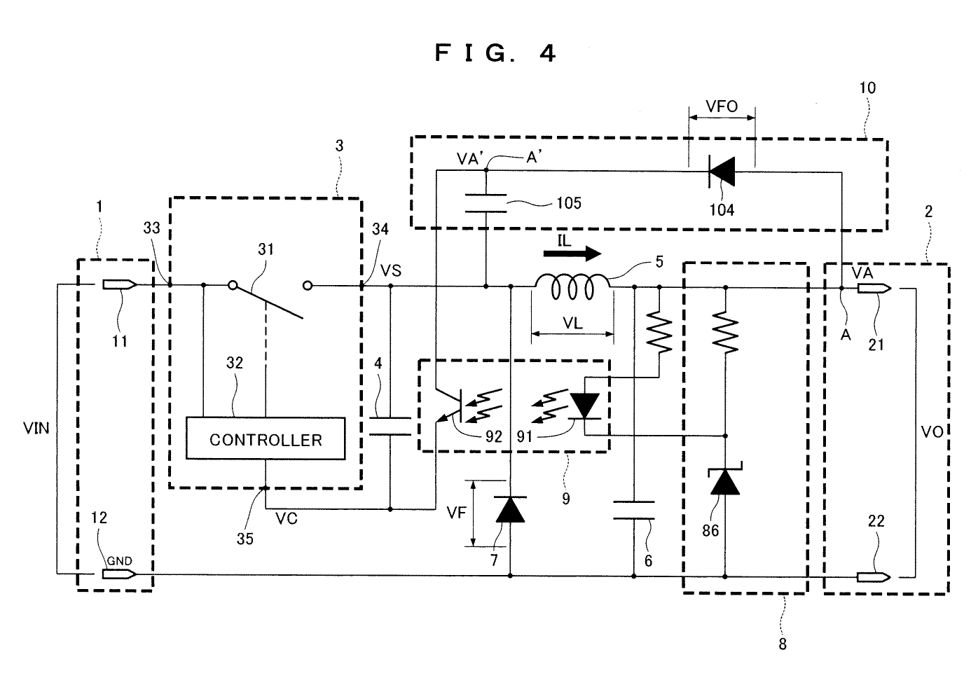

FIG. 4 is a schematic circuit diagram showing the configuration of the switching power supply circuit according to the third embodiment. The circuit capable of detecting the error of the output voltage VO of the output part 2, converting the error into the current signal, and passing the current through the photodiode 91 of the photocoupler 9 in the first embodiment can be made up of, for example, a Zener diode 86 as shown in FIG. 4.

According to fluctuations in an output voltage VO of an output part 2, a current generated by Zener breakdown passes through the Zener diode 86 and the current flows from the cathode of a photodiode 91. Thus the current passes through the photodiode 91 according to the error of the output voltage VO of the output part 2.

### Fourth Embodiment

A switching power supply circuit according to a fourth embodiment of the present invention will be described below.

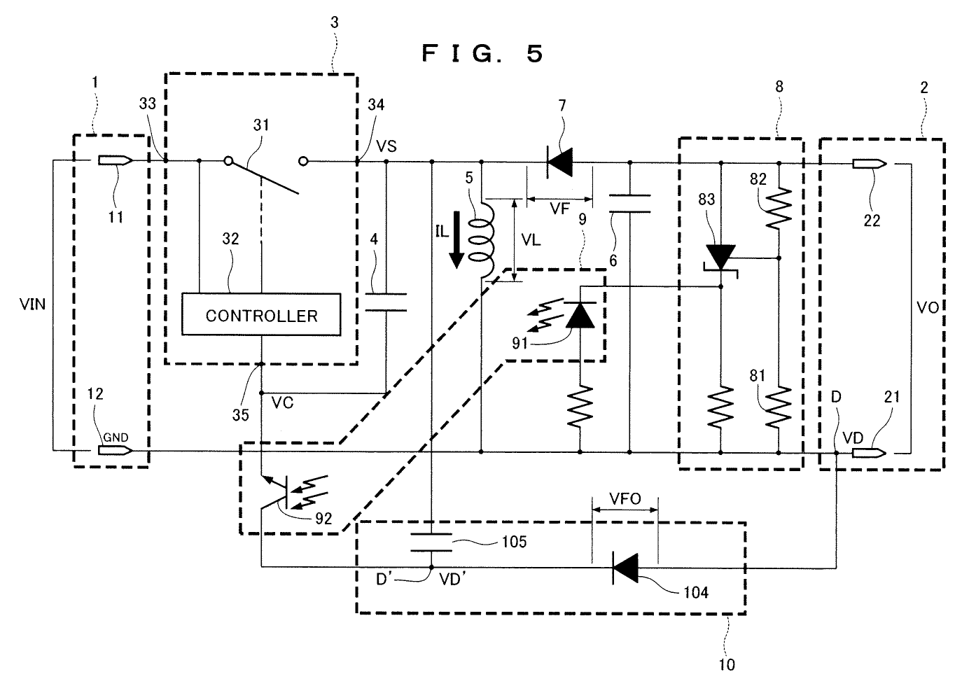

FIG. 5 is a schematic circuit diagram showing the configuration of the switching power supply circuit according to the fourth embodiment. The first embodiment described the step-down non-isolated power supply circuit in which the positive voltage terminal 11 of the input part 1 is connected to the three-terminal switching regulator 3 and the negative voltage terminal 12 of the input part 1 is connected to the negative voltage terminal 22 of the output part 2. For example, as shown in FIG. 5, the power supply circuit can be a polarity-inverting non-isolated power supply circuit in which a positive voltage terminal 11 of an input part 1 is connected to a three-terminal switching regulator 3 and a negative voltage terminal 12 of the input part 1 is connected to a positive voltage terminal 21 of an output part 2.

The following will describe the operations of the switching power supply circuit configured thus.

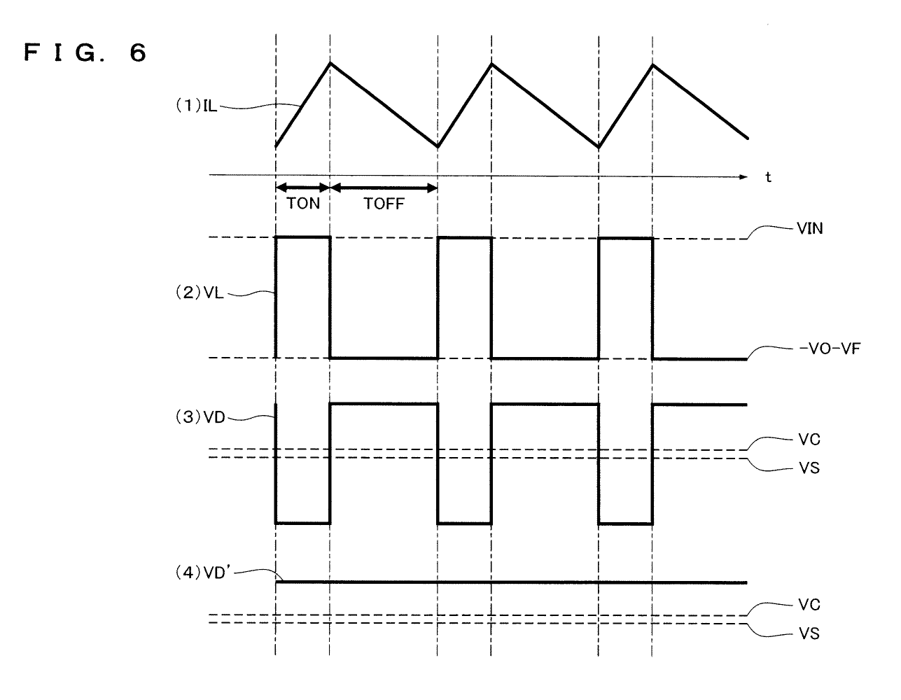

FIG. 6 is a waveform chart showing the operations of the switching power supply circuit according to the fourth embodiment. In FIG. 6, a waveform (1) IL is an image of a current passing through a coil 5, a waveform (2) VL is an image of a potential difference on the coil 5, a waveform (3) VD is an image of a voltage of the positive voltage terminal 21 of the output part 2, and a waveform (4) VD, is an image of a voltage of the collector of a phototransistor 92.

In FIG. 6, TON is an on period of a switch 31, TOFF is an off period of the switch 31, VS is a voltage of a source terminal 34, and VC is a voltage of a control terminal 35. The waveform (3) VD and the waveform (4) VD′ are operation waveforms relative to the voltage VS of the source terminal 34. Further, the operation waveforms of FIG. 6 are created in a forward direction that is the direction of an arrow for a current IL of the coil 5 shown in FIG. 5.

When an input voltage VIN is applied to the input part 1, the input voltage VIN is applied to a drain terminal 33 of the three-terminal switching regulator 3. When the coil 5 has an inductance of L, the inclination of the time variation of the current IL passing through the coil 5 is proportionate to VL/L. Thus as indicated by the waveform (2) in FIG. 6, in the on period TON of the switch 31, the drain terminal 33 and the source terminal 34 are electrically connected to each other to apply the input voltage VIN to the source terminal 34 of the coil 5, causing a potential difference VIN on the coil 5 from the source terminal 34 to the output part 2. The value of the current IL in the forward direction increases and energy is charged to the coil 5.

In the off period TOFF of the switch 31, the drain terminal 33 and the source terminal 34 are electrically disconnected from each other and a current passes through a diode 7, so that the potential VS of the source terminal 34 has a potential (−VO−VF) reduced from a voltage −VO of a negative voltage terminal 22 of the output part 2 by a forward voltage drop VF of the diode 7 and the potential VD of the positive voltage terminal 21 of the output part 2 becomes higher than the potential VS of the source terminal 34. Thus the value of the current IL passing through the coil 5 decreases and the energy having been charged in the coil 5 is outputted to the output part 2. A capacitor 6 smoothes the current IL and generates the output voltage −VO. An output current IO is the mean value of the current IL.

In steady-state oscillation, the on period TON and the off period TOFF are repeated and energy is supplied to the output part 2.

Relative to the voltage VS of the source terminal 34, as indicated by the waveform (3) of FIG. 6, the voltage VS of the source terminal 34 is higher than the voltage VD of the positive voltage terminal 21 of the output part 2 in the on period TON of the switch 31 because a voltage is generated on the coil 5 in the forward direction, and the voltage VD of the positive voltage terminal 21 of the output part 2 is higher than the source terminal voltage VS in the off period TOFF of the switch 31 because a voltage is generated on the coil 5 in the opposite direction from the forward direction. In steady-state oscillation, only when the collector voltage VD′ of the phototransistor 92 is lower than VD by a forward voltage drop VFO of a diode 104, a current is supplied from the positive voltage terminal 21 of the output part 2 to the collector of the phototransistor 92 and VD′ is formed.

In the off period TOFF of the switch 31, as indicated by the waveform (3) of FIG. 6, the voltage VD of the positive voltage terminal 21 of the output part 2 is higher than the voltage VS of the source terminal 34 and the voltage VC of the control terminal 35. Thus as indicated by the waveform (4) of FIG. 6, a current passes through the diode 104 and the voltage VD′ is formed. The formed VD′ is lower than VD by the forward voltage drop VFO of the diode 104. In this case, the value of an output voltage VO has to enable the formed VD′ to be higher than the voltage VS of the source terminal 34 and the voltage VC of the control terminal 35.

In the on period TON of the switch 31, the voltage VD of the positive voltage terminal 21 of the output part 2 is lower than the voltage VC of the control terminal 35, so that a current does not pass through the diode 104 and VD′ is kept by a capacitor 105 so as not to be lower than the voltage VC of the control terminal 35. Consequently, VD′ is always higher than the voltage VC of the control terminal 35 and the power supply voltage of the phototransistor 92 is ensured. The phototransistor 92 can simultaneously feed a current steadily back to a controller 32 according to the error of the output voltage VO and supply the power supply voltage of the controller 32, thereby achieving the aforementioned power supply control.

In this way, the polarity-inverting non-isolated power supply circuit can also supply the power supply voltage of the phototransistor 92 only with the single diode 104 and the single capacitor 105, achieving the applicability of an auxiliary power supply 10 of the present embodiment.

In the polarity-inverting non-isolated power supply circuit of FIG. 5, an output voltage detection part 8 is made up of resistors 81 and 82 and a shunt regulator 83. The configuration of the output voltage detection part 8 is not particularly limited as long as the output voltage detection part 8 can detect the error of the output voltage VO of the output part 2, convert the error into a current signal, and pass the current through a photodiode 91 of a photocoupler 9.

The output voltage detection part 8 can be evidently made up of, for example, the first resistor 81, the second resistor 82, the Zener diode 84, and the transistor 85 as shown in FIG. 3 and the output voltage detection part 8 can be configured using the Zener diode 86 as shown in FIG. 4.

In the foregoing embodiments, the auxiliary power supply 10 is made up of the single diode 104 and the single capacitor 105. The rectifying device is not limited to a diode and any device may be used as long as the device has a factor passing a current only in a direction from the positive voltage terminal 21 of the output part 2 to the collector of the phototransistor 92.

Further, in the foregoing embodiments, the non-isolated power supply circuit is configured using the coil 5. The configuration of the non-isolated power supply circuit is not particularly limited and an energy transfer element from the three-terminal switching regulator 3 to the output part 2 may be any device as long as the device has an inductor component.

What is claimed is:

1. A switching power supply circuit, comprising:
a switch for switching an input voltage;
an energy transfer element for charging and outputting energy obtained by switching of the switch;
an output generation part for outputting a voltage while charging the energy outputted from the energy transfer element;
an output voltage detection part for detecting the output voltage of the output generation part and generating a detection signal corresponding to the output voltage;
a transfer device for outputting a transfer signal corresponding to a value of the detection signal generated by the output voltage detection part;
an auxiliary power supply for supplying a power supply voltage for generating the transfer signal to the transfer device, based on the output voltage of the output generation part; and
a controller for generating a driving signal for controlling the switching of the switch according to a value of the transfer signal from the transfer device,
wherein the auxiliary power supply is only made up of:
a rectifier device which is connected between one end of the output generation part and the transfer device and passes a current from the one end of the output generation part only to the transfer device, and
a smoothing device for keeping and smoothing a potential of a joint of the rectifier device with the transfer device while using a switching output of the switch as a reference potential.

2. The switching power supply circuit according to claim 1, wherein the controller has a terminal fed with the transfer signal and the power supply voltage for generating the driving signal, and is fed with a current as the transfer signal.

3. The switching power supply circuit according to claim 2, wherein the transfer device is a photocoupler made up of a photodiode and a phototransistor, the phototransistor has a collector connected to the auxiliary power supply and an emitter connected to the controller, and the transfer signal is outputted from the emitter of the phototransistor.

4. The switching power supply circuit according to claim 1, wherein the output voltage detection part is made up of:
a first resistor and a second resistor which are connected in series and inserted between both ends of the output generation part; and
a current signal output device for outputting a current signal corresponding to a divided voltage value of a joint of the first resistor and the second resistor, as the detection signal to the transfer device.

5. The switching power supply circuit according to claim 4, wherein the current signal output device is made up of a shunt regulator which uses the divided voltage value as a reference voltage, and has a cathode connected to the transfer device and an anode connected to the one end of the output generation part.

6. The switching power supply circuit according to claim 4, wherein the current signal output device is made up of:
a third resistor and a Zener diode which are connected in series and inserted between both ends of the output generation part; and
a transistor having a base connected to a joint of the first resistor and the second resistor, a collector connected to the transfer device, and an emitter connected to a joint of the third resistor and the Zener diode.

7. The switching power supply circuit according to claim 1, wherein the output voltage detection part is made up of a Zener diode inserted between the one end of the output generation part and the transfer device.

8. The switching power supply circuit according to claim 1, wherein the controller generates the driving signal for controlling an on time of the switch according to the value of the transfer signal so as to keep constant the output voltage detected by the output voltage detection part.

9. The switching power supply circuit according to claim 1, wherein the controller generates the driving signal for controlling a peak value of current passing through the energy transfer element from the switch in an on period of the switch, the peak value being controlled according to the value of the transfer signal so as to keep constant the output voltage detected by the output voltage detection part.

10. The switching power supply circuit according to claim 1, wherein the controller generates the driving signal for controlling a switching frequency of the switch according to the value of the transfer signal so as to keep constant the output voltage detected by the output voltage detection part.

11. The switching power supply circuit according to claim 1, wherein the controller generates the driving signal for controlling a switching operation period and a switching stop period of the switch according to the value of the transfer signal so as to keep constant the output voltage detected by the output voltage detection part.

12. The switching power supply circuit according to claim 1, wherein the switching power supply circuit is a positive voltage output type in which a positive voltage side of the input voltage is connected to the switch and a negative voltage side of the input voltage is connected to a negative voltage side of the output voltage detected by the output voltage detection part.

13. The switching power supply circuit according to claim 1, wherein the switching power supply circuit is a negative voltage output type in which a positive voltage side of the input voltage is connected to the switch and a negative voltage side of the input voltage is connected to a positive voltage side of the output voltage detected by the output voltage detection part.
